(19) United States
(12) Patent Application Publication
(10) Pub. No.: US 2005/0042984 A1
(43) Pub. Date: Feb. 24, 2005

(54) Apparatus and techniques for maximizing satellite link availability in the presence of satellite system induced random disconnections

(75) Inventor: Raymond J. Kolar, Grant, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Reliable System Services Corp., Melbourne, FL (US)

(21) Appl. No.: 10/823,361

(22) Filed: Apr. 13, 2004

Related U.S. Application Data
(60) Provisional application No. 60/496,817, filed on Aug. 21, 2003.

(51) Int. Cl. H04B 7/19

(52) U.S. Cl. 455/13.2; 455/12.1

(57) ABSTRACT

Reliability of a connection between two stations over a satellite link is improved by having a station periodically send a heartbeat message. Failure to receive a heartbeat message within a predetermined time results in a disconnect being declared and an attempt to reconnect to the other station.

### CROSS REFERENCE TO RELATED APPLICATIONS

This application incorporates by reference in its entirety and claims priority to U.S. Provisional Application 60/496,817 filed Aug. 21, 2003, by inventor Raymond Joseph Kolar.

### STATEMENT OF FEDERALLY RESEARCH OF DEVELOPMENT

This invention was developed in the course of performance of a contract (May 16, 2002 thru Oct. 15, 2003) with the Air Force Flight Test Center—AFFTC/XPDT, Edwards AFB, Calif. 93524, to develop a Robust Affordable Flight Safety System (RAFS). The contract number is F04611-02-C-0009.

### BACKGROUND OF THE INVENTION

1. Field of the Invention

This application is directed to techniques maximizing satellite link availability and to methods, apparatus, systems, computer program products, and methods of doing the same.

2. Description of Related Art

Historically, Low earth Orbit (LEO) satellites provided only Store & Forward data transfer capability. LEO satellites orbit the earth at altitudes of (generally) 500 to 1,000 miles, and require a large number of satellites for instantaneous global coverage (i.e., being in view of a satellite anywhere on the globe), because of their relatively small ‘footprint’ on the earth's surface. Depending on orbital altitude, as many as 45 satellites may be required. Because of their lower altitudes and significantly lower RF path losses, LEO systems require the lowest power to communicate with users.

Real time, continuous data transfers could not be provided by legacy systems because of the complexity and quantity of satellites in the satellite system. A new generation of LEO satellites, however, is providing a real time data transfer capability. One example of such a satellite system is Iridium.

The Iridium satellite system is an existing network of a large number of low earth-orbit Iridium satellites designed to deliver reliable real-time voice, data, paging, and facsimile communications all over the planet. Full duplex data rates in excess of 2.4 kbps are supported. Iridium uses a ‘switched’ architecture, ensuring true global coverage. Access is via a cell-phone like unit with omni-directional antenna, or a data modem unit.

Part of the system architecture is Iridium's ability to handoff calls between satellites. According to Iridium engineers, the handoff mechanism is very robust, and operates in a similar fashion to cellular telephone handoffs. The LBT [Land Based Terminal] continuously monitors Received Signal Strength (RSS) of the satellites, and will handoff, seamlessly, at the appropriate time. Because of the packet nature of the system, no loss of data occurs in the handoff process.

Iridium, by its nature, is designed to be a highly reliable system. According to Iridium, independent testing has indicated a call generation/connection rate exceeding 98%. This number, however, is a user scenario dependent number. Additionally, the random disconnect rates and intervals were not available from Iridium LLC.

### BRIEF SUMMARY OF THE INVENTION

Independent testing of the Iridium System by Reliable System Services Corporation, assignee of the invention discussed herein, indicated a system availability of approximately 0.980; i.e., a data link could be established, and maintained for 98% of the time, excluding planned maintenance or catastrophic satellite system failures. System availability is defined as:
A=(Total Mission Time-Time Disconnected)/Total Mission Time

For example, assuming a 24 hour mission duration (data being transferred continuously over the link), If the link were disconnected for a period of 0.5 hour due to the random disconnect phenomena, the System Availability is:
A=(24−0.5)/24=0.9791

This availability is too low for some applications needing a high probability of data delivery.

Another problem is the duration of the disconnect In the example above, the same Availability number is achieved whether the disconnect outage is a single 30 minute outage or many short duration outages. In some applications, the length of the outage is of significant concern. During the testing, it was noted that the disconnect intervals as sensed by the source and destination were different. Further, the presence of a disconnect could not be readily established by conventional means.

One aspect of the invention is directed to minimizing the disconnect interval using a protocol and algorithmic approach.

Another aspect of the invention is directed to maximizing satellite system availability, given that these random disconnects will, and do, occur.

### BRIEF DESCRIPTION OF THE DRAWINGS

The invention is described in more detail with reference to the following drawings, in which:

FIG. 1 illustrates the sending of bidirectional data from a first station (Ground) over a satellite link to a second station (Mobile).

FIG. 2 illustrates the sending of bidirectional data over a satellite link using a Satellite Earth Station.

FIG. 3 is a flow chart of a preferred process for use at a mobile station to improve satellite system availability.

FIG. 4, is a flow chart of a preferred process for use at a ground station to improve satellite system availability.

FIG. 5 is a block diagram of a processor suitable for use at a ground or mobile station for carrying out the processes of FIGS. 3 and 4.

### DETAILED DESCRIPTION OF THE INVENTION

The Invention includes a software protocol and algorithm that minimizes the effects of random satellite system induced disconnects, thus significantly improving system availability, and reducing the duration of disconnect intervals.

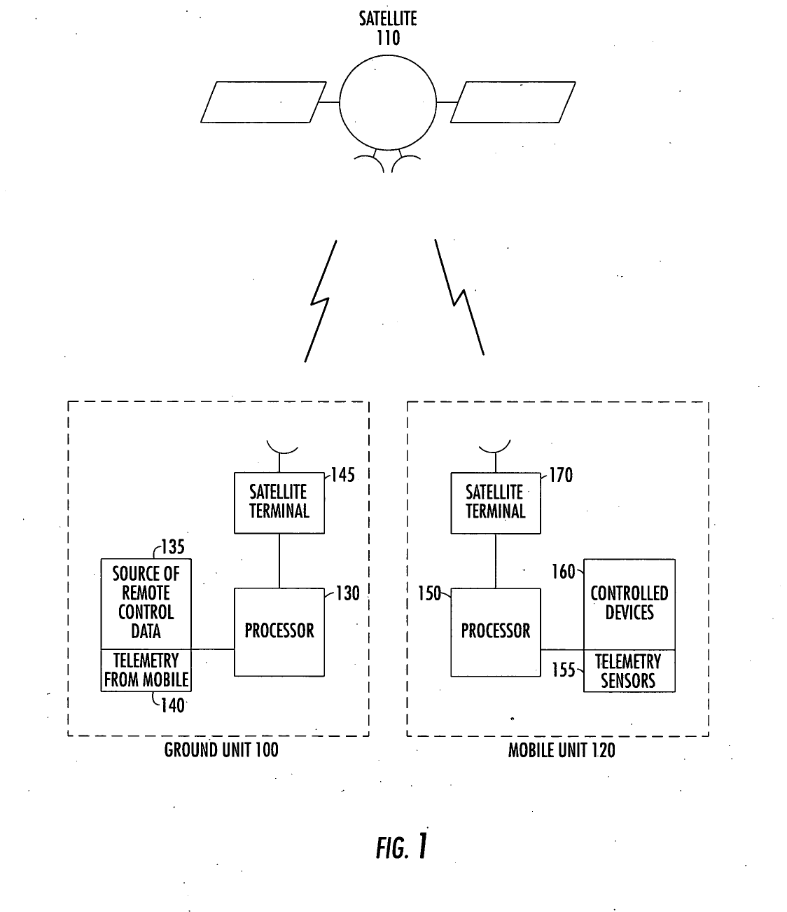

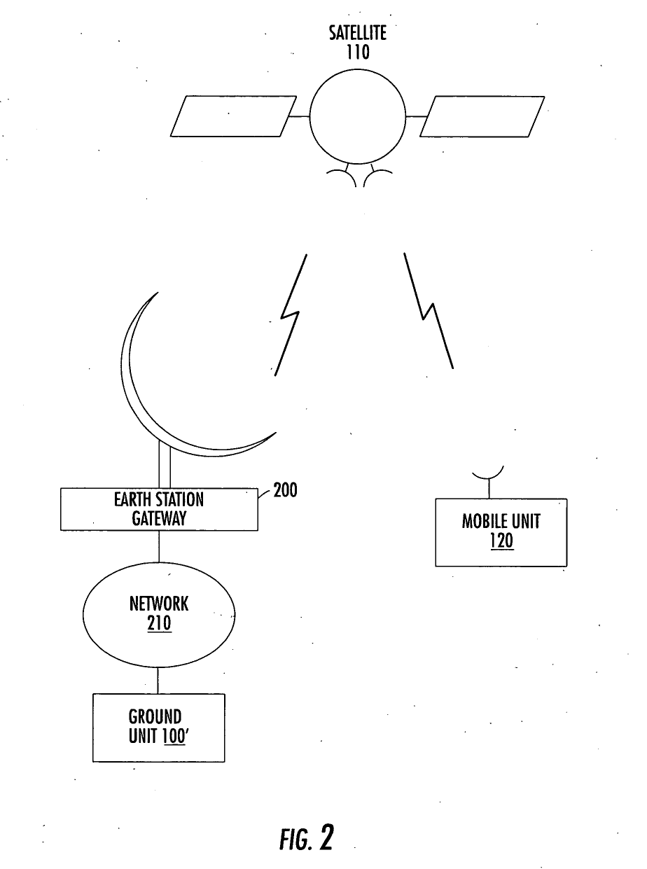

The invention will now be described with reference to the systems illustrated in FIG. 1 and in FIG. 2. In FIG. 1, ground unit 100 connects to a mobile unit 120 by way of satellite 110. For purposes of this example only, the ground unit will be sending a remote control data 135 to the mobile unit where it will be utilized to activate controlled devices 160. In the reverse direction telemetry sensors, such as camera data and instrumentation data, is transmitted from the mobile unit 120 back over the satellite link to ground unit 100 where it is displayed or utilized as indicated by telemetry from mobile section 140. Satellite terminals 145 and 170 shown in FIG. 1 can be as small as simple handheld terminals the size of cellular telephones, notebook size terminals or larger satellite terminals for fixed or mobile operation. The particular type of satellite terminal utilized will depend upon a particular application. The principal function of the satellite terminals 145 and 170 is to establish a communications link over the satellite 110 with another terminal.

Satellite terminals of the type described usually have an access port for receiving data to be transmitted across the satellite link.

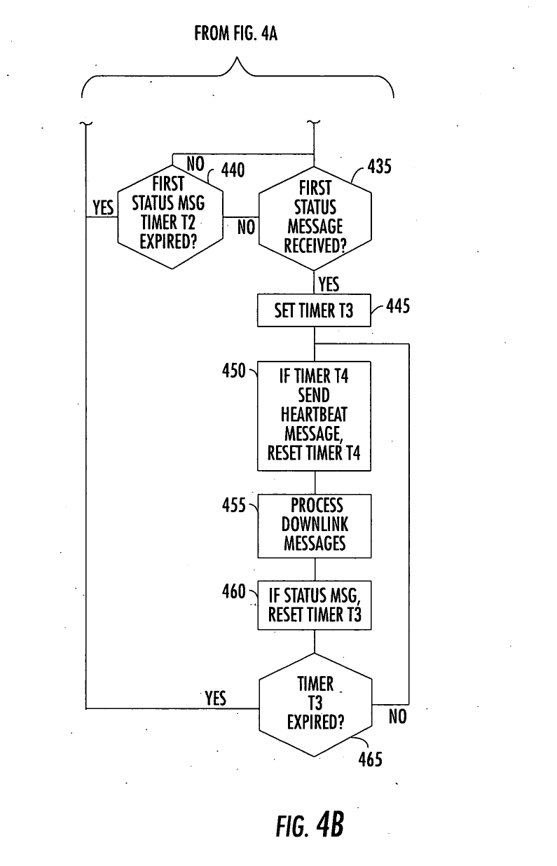

Processor 130 organizes the data from the source of the remote control data 135 into a format suitable for transmission over the satellite terminal 145 and satellite 110. the processor also demultiplexes signals from the telemetry sensors 155 of the mobile unit which have been received over the satellite 110 and the satellite terminal 145 and displays or otherwise applies the signals to the appropriate instrumentation entities indicated by telemetry from mobile 140 of the ground unit. In addition, processor 130 implements the process for use at a ground station for improving satellite system availability. This will be described more in detail in conjunction with FIG. 4.

Mobile unit 120 contains a processor 150. Processor 150 demultiplexes and delivers data received from the satellite to over satellite terminal 170 and applies the appropriate control signals indicated by the received data to the control devices 160. In addition, processor 150 receives, data from telemetry sensors, such as a camera and instrumentation, multiplexes it and sends it over satellite terminal 170 and the satellite 110 to the ground unit 100.

In the example shown in FIG. 1, the ground unit can be a fixed or mobile control station and the mobile unit can be a remote controlled airborne vehicle.

FIG. 2 illustrates a variation on the architecture of FIG. 1. In FIG. 2, the ground unit, instead of having a dedicated satellite terminal 145, connects to an earth station gateway 200 via network 210. The earth station gateway is typically a fixed access point utilized for establishing communications over a satellite system.

Network 210 can be any type of network suitable for connecting a data from a processor to the earth station. Typically, the network 210 would be a land based telephone system. That way, ground units can be located anywhere and be able to connect to the earth station gateway for controlling a mobile unit 120.

In FIG. 2, the ground unit is labeled 100′ (as opposed to 100) to indicate that the ground unit is not identical with that shown in FIG. 1. However, the only significant difference is that the ground unit does not require a satellite terminal 145. Rather the ground unit will connect to over network 210 to the earth station gateway for communications with the mobile unit as previously described in conjunction with FIG. 1.

For the purpose of discussion assume: a Ground Station (Ground), which is connected to the satellite system either via the ether (FIG. 1) or via a wire or network connection (FIG. 2) to the Satellite Gateway Earth Station; and a Mobile Station (Mobile), connected to the Satellite System via the ether. The Ground establishes the data connection with the Mobile by “dialing”, or otherwise connecting to, the Mobile. Data is transferred over a developed software protocol in accordance with the Invention. The software protocol is a packet based protocol, with a defined message structure. Messages can be defined as to type (commands, status, etc). One special message type defined by the Invention is a Heartbeat Message.

Heartbeat Messages are transmitted periodically by the Ground and the Mobile. An algorithm is employed to determine a link disconnection; i.e., if no Heartbeat Message is received within X seconds, a disconnect is declared. Both the Mobile and Ground will force a disconnect, then the Ground will reesblish a connection. Of particular import are the settings for the various algorithm timers and reconnection timers; i.e., when to declare a disconnect, how long to wait until a reconnection attempt is made, and how long to wait between reconnection attempts. Exemplary parameters for these settings are given hereinafter.

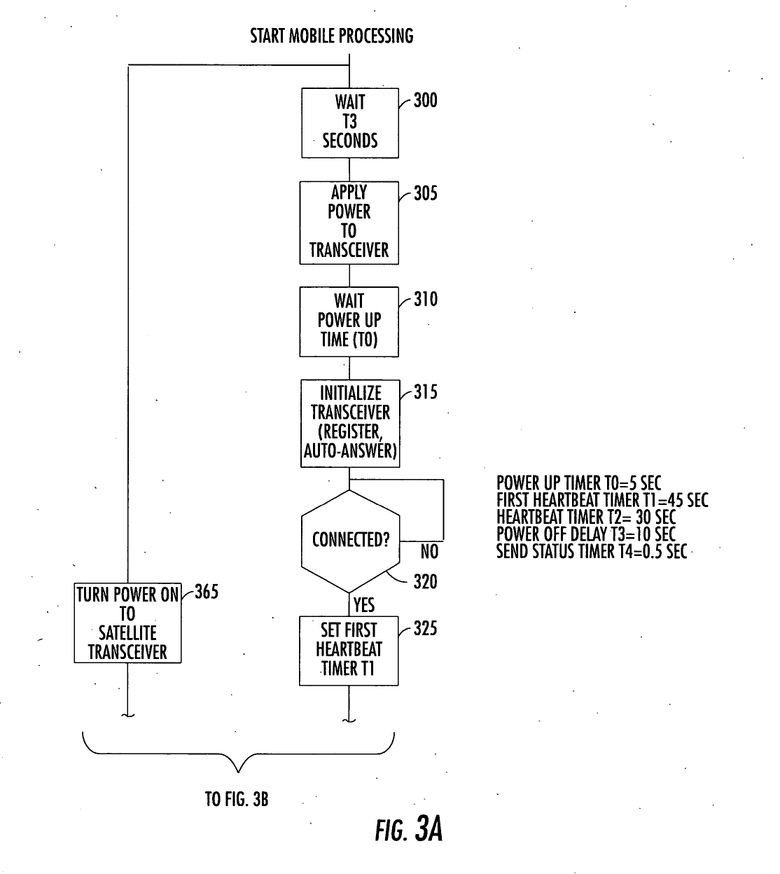

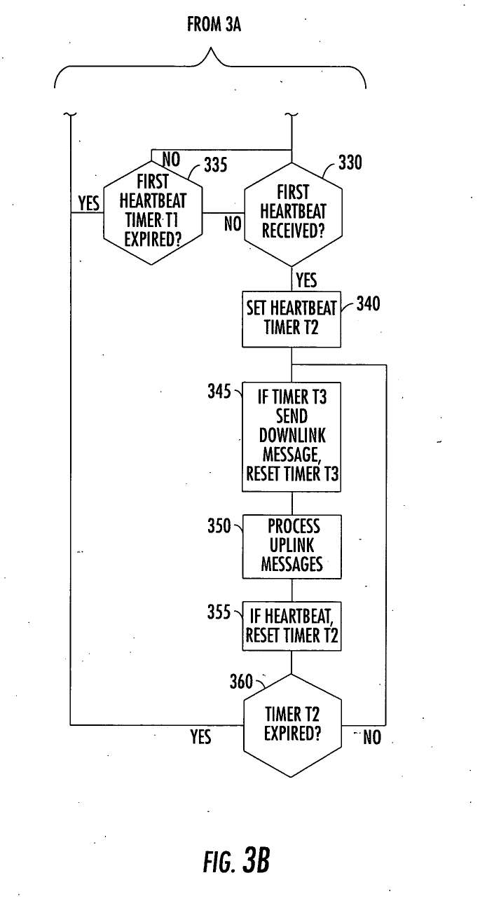

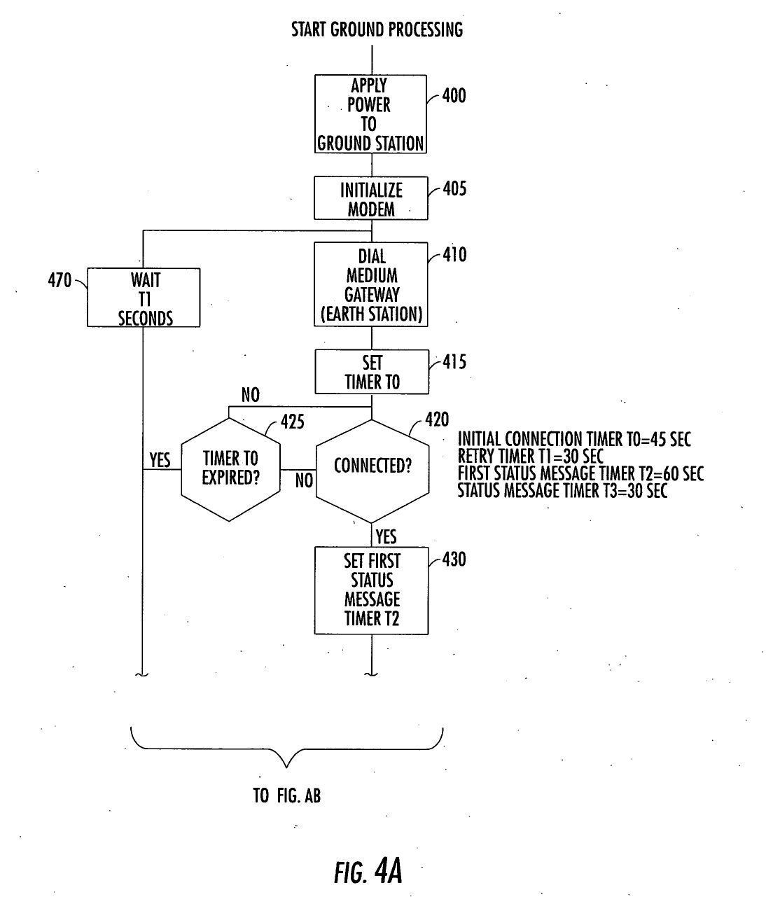

FIG. 3 shows a process that is invoked at the start of mobile station processing. FIG. 3 is a flow chart of a preferred process for use at a mobile station to improve satellite system availability. As shown in FIG. 3, upon the start of mobile processing, for example, a power up, a waiting period of T3 seconds is established (300), for example by setting a timer. Power is then applied to the transceiver (305) and a power up waiting time T0 is established (310), for example, by setting a timer. When power up is completed, the transceiver is initialized (315) and a check is made to determine if the terminal is connected to the satellite system. If it is not, the system will periodically check for a connection until it is established (320—yes). Once a connection is established, a first heartbeat timer T1 is set (325). If a first heart beat has not been received (330—no) prior to expiration of the timer T1, a check will be made to see if the timer T1 has expired (335—yes). If the timer T1 has expired, the satellite transceiver will be powered down (365) and the start up sequence (300) reinitiated.

If a heart beat is received (330—yes) during the first heart beat timer window a second heartbeat timer T2 will be set (340). As soon as another timer, T3, times the transmission of downlink messages. A downlink message is sent in each T3 epoch. After a since that as timer T3 expires (345) a status message will be sent down link from the mobile over the satellite to the ground unit. The mobile will continue to process up link messages (350) and if a heart beat message is received (355) the timer T2 will be reset. If timer is not expired, steps 345, 350 and 355 will be repeated until the timer T2 does expire. If timer T2 does expire, the satellite transceiver will be powered off (365) and the power up sequence will begin again with step 300.

FIG. 4 show a process that is invoked at the start of ground terminal processing. FIG. 4 is a flow chart of a preferred process for use at a ground station to improve satellite system availability. This exemplary process is considered suitable for use in conjunction with the FIG. 2 architecture. When one desires to start ground unit processing, power is applied to the ground station (400). A modem on other connection device associated with the processor 130 of ground unit 100′ is initialized (405). The processor connects with the Iridium gateway (earth station) (410). A timer T0 is established (415) and a check is made to see if a connection has been successfully established to the satellite system over the earth station (420). If no connection has been established, a check is repeatedly made until timer T0 expires (425). If timer T0 expires (425—yes), after a delay of T1 seconds (470) another attempt will be made to dial the Iridium gateway earth station. If connection is successfully established (420—yes) a first status message timer T2 will be established (430), for example by setting a timer. If the ground station has not received a first status message before timer T2 expires, (440—no) the check will be repeated until the expiration of timer T2. At that time (440—yes), after a wait of T1 seconds (470), another attempt will be made to dial the Iridium gateway earth station. If, however, a first status message is received (435—yes) a timer T3 will be set (445). A heart beat message is sent every T4 seconds and the timer T4 is reset (450). Messages arriving at the ground unit from one or more mobile stations will be processed (455). If the status message for a particular mobile unit is received (460), timer T3 will be reset. As long as timer T3 is not expired, steps 450, 455 and 460 will be repeated. Once timer T3 expires, after a wait of T1 seconds (470) a new attempt will be made to dial the Iridium gateway earth station to establish a connection.

Parameter optimization is important. For example, Satellite systems sometimes exhibit significant latency (time delay between when a message is transmitted by the Ground/Mobile, and received by the Mobile/Ground). It is not desirable to declare a disconnect prematurely, since this could actually result in a degradation of system availability (disconnecting when, in actuality, no disconnect occurred).

Ground Unit Timing Parameters

Initial Connection Timer T0=45 sec (415)

This value is based on a disconnect occurring, and the statistical probability distribution of reconnect times. Too short a time results in “accidental” redialings and increased time, because the ground unit will “force” a disconnect even when the Iridium system is in the middle of connecting. Too long a time results in increased reconnection times. The 45 seconds was set to approximately the 95% probability point (non optimized as noted), which means that 95% of reconnection attempts are less the 45 seconds.

Retry First Heartbeat timer T1=30 sec (470)

Same as above. The parameter will be experimentally adjusted depending on the statistical distribution of the reconnect, vs initial connect distribution. Possibly, they will be the same.

First Status message timer T2=60 sec (430)

Sometimes, a connection does not result in data flow. In this case, one would want to force a disconnect The value may be somewhat high, but it was the value used for a demonstration. A truer value would likely be closer to −10 seconds, and be based on the statistical distribution of time-to-receive first status value, given a successful connection, jointly with the distribution of latency times.

Status Message Timer T3=30 sec (445)

Similar to above, but based on the latency distribution. High latency values are possible with Iridium, and other systems. The 30 seconds was selected to reflect the 0.9999 probability; i.e, 99.99% of all packets show latencies under 30 seconds. Decreasing this value will increase the number of false forced disconnects, but decrease the wait time when a “real” disconnect has occurred. The actual value can be determined by experimentation with a particular satellite system.

Mobile Unit Timing Parameters:

Power up Timer T0=5 sec (310)

The Mobile Unit can be a processor based device as shown or preferably a firmware based device. The 5 seconds reflects the initialization and modem set up time. It is set to ensure adequate time for the modem to initialize.

First Heartbeat Timer T1=45 sec (325)

As with the Ground Unit end of the connection, sometimes a connection does not result in data flow to the mobile. In this case, we want to force a disconnect based on the data flow, rather than waiting for Iridium to declare a connect failure. The 45 seconds may be somewhat high, but it was the value used for a demonstration. It differs from the Ground Unit first status message value of 60 seconds based on observed results. A truer value may be closer to −10 seconds, and should be based on the statistical distribution of time-to-receive first heartbeat value, given a successful connection, jointly with the distribution of latency times.

Heartbeat Timer T2=30 sec (340)

Similar to above, but based on the latency distribution. High latency values are possible with Iridium, and other systems. The 30 seconds was selected to reflect approximately the 0.9999 probability; i.e., 99.99% of all packets show latencies under 30 seconds. Decreasing this value will increase the number of false forced disconnects, but decrease the wait time when a “real” disconnect has occurred. The actual value can be determined more precisely by experimentation with a particular satellite system.

Power Off Delay T3=10 seconds (300)

It was found that the only effective way to disconnect the satellite modem is to power-down the unit. Software commanding proved ineffectual, due to the modems autonomous interaction with the satellites. The 10 seconds was selected to ensure that the modem and computer related hardware is completely de-energized, prior to initiating a modem reset (power up). The 10 seconds is based on experimentation, and is modem dependent.

Send Status Timer T4=0.5 sec (345)

This value reflects the time for each status message transmission. It must be high enough to ensure that the Ground Unit will continue to receive packets (see Ground Unit Status Timer). It also sets the effective data throughput of the system (not critical for the described connect/reconnect timing algorithms.

The term “ground” as used herein in reference to a terminal communicating with a “mobile” terminal over a satellite, does not necessarily imply that the ground terminal is stationary. Similarly, the term mobile does not necessarily imply that the terminal is not on the ground. Typically, the ground terminal may be fixed or moving and the mobile terminal may be airborne or moving on the ground. The invention may be utilized with any two terminals communicating over a satellite or other relay station.

The protocols and algorithms may be implemented in software and may run on a computing device or system.

Processor

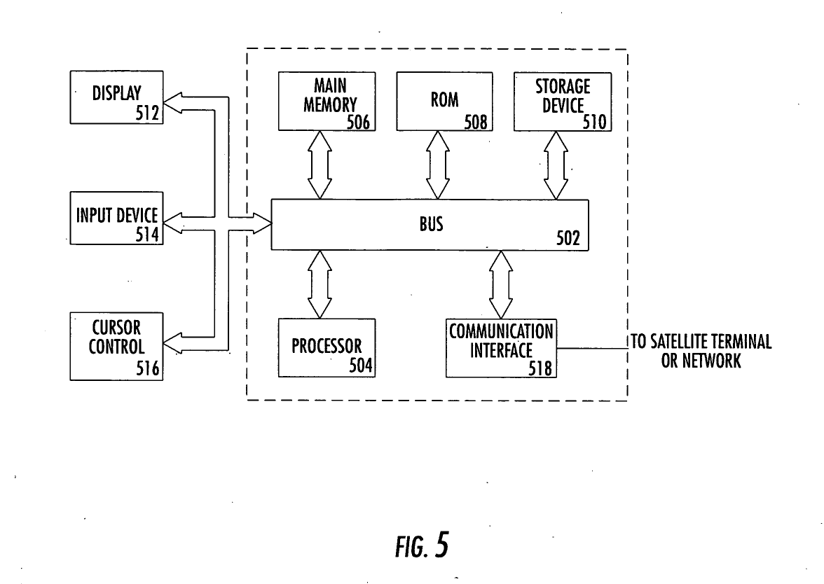

As shown in FIG. 5, an exemplary computer arrangement or system usable as the processors 130 and 150 includes a bus (502) or other communication mechanism for communicating information, and a processor (504) coupled with bus for processing information. A computer system typically includes a main memory (506), such as a random access memory (RAM) or other dynamic storage device, coupled to the bus for storing information and instructions to be executed by the processor. Main memory also may be used for storing temporary variables or other intermediate information during execution of instructions to be executed by the processor. A computer system may further includes a read only memory (508) (ROM) or other static storage device coupled to the bus for storing static information and instructions for the processor. A storage device (510), such as a magnetic disk or optical disk, may be provided and coupled to the bus for storing information and instructions.

Some computer systems may be coupled via the bus to a display (512), such as a cathode ray tube (CRT), for displaying information to a computer user. Some computer systems may include an input device (514), including alphanumeric and other keys, coupled to bus for communicating information and command selections to a processor. Another type of user input device may be a cursor control device (516), such as a mouse, a trackball, or cursor direction keys for communicating direction information and command selections to a processor and for controlling cursor movement on a display. This input device typically has two degrees of freedom in two axes, a first axis (e.g., x) and a second axis (e.g., y), that allows the device to specify positions in a plane.

A computer system typically operates in response to a processor executing one or more sequences of one or more instructions contained in memory. Such instructions may be read into memory from another computer-readable medium. Execution of the sequences of instructions contained in memory causes a processor to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to a processor for execution. Such a medium may take many forms, including but not limited to, non-volatile media, volatile media, and transmission media. Non-volatile media includes, for example, optical or magnetic disks. Volatile media includes dynamic memory. Transmission media may include coaxial cables, copper wire and fiber optics, including the wires that comprise bus 102. Transmission media can also take the form of acoustic or electromagnetic waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to a processor for execution. For example, the instructions may initially be carried on a magnetic disk of a remote computer. The remote computer can load the instructions into its dynamic memory and send the instructions over a telephone line using a modem. A modem local to a computer system can receive the data on the telephone line and use an infra-red transmitter to convert the data to an infra-red signal. An infra-red detector can receive the data carried in the infra-red signal and appropriate circuitry can place the data on a bus. The Bus carries the data to main memory, from which a processor retrieves and executes the instructions. The instructions received by main memory-may optionally be stored on storage device either before or after execution by the processor.

A computer system may also includes a communication interface coupled to a bus. The communication interface may provide a two-way data communication coupling to a network link. For example, a communication interface may connect data to a satellite link. In any implementation, the communication interface may send and receive electrical, electromagnetic or optical signals that carry digital data streams representing various types of information such as protocol information and message as described herein. These can be exemplary forms of carrier waves transporting the information.

Received code may be executed by a processor as it is received, and/or stored in a storage device for later execution. In this manner, a computer system may obtain application code in the form of a carrier wave.

The algorithms and protocols associated with the invention may be distributed on a computer readable medium for later loading into a computer system for use. Computer systems as described herein incude inter alia handheld, portable, mobile and fixed ground terminal devices for communicating over a satellite.

The invention described herein is not limited to the specific examples shown, but rather has broad applicability to communications generally.

1. A method for improving the effective availability of a connection between terminals over a satellite link, comprising the steps of:
a. periodically sending a heartbeat message across the connection;
b. treating failure to receive a heartbeat message within a predefined interval as a disconnect; and
c. establishing a new connection between said terminals across the satellite link in response to said disconnect.

2. The method of claim 1 in which heartbeat messages are sent by at least one terminal.

3. The method of claim 2 in which heartbeat messages are sent by both terminals participating in a connection.

4. The method of claim 1 in which the step of treating failure to received a heartbeat message within a predefined interval as a disconnect comprises the step of turning off power to a satellite terminal and reapplying power to said terminal after a predefined interval.

5. The method of claim 4 in which the step of treating failure to received a heartbeat message within a predefined interval as a disconnect further comprises the step of dialing a satellite gateway station.

6. The method of claim 4 in which the step of treating failure to received a heartbeat message within a predefined interval as a disconnect further comprises the step of dialing the number of one of said terminals participating in said connection.

7. A communications unit for sending information to a remote unit over a statellite, comprising: a processor for sending information to a remote unit over a satellite, said information comprising a heartbeat message at predetermined intervals.

8. The communications unit of claim 7, in which said information further comprises information for remotely controlling said remote unit.

9. The communications unit of claim 7, in which said processor detects failure to receive a heartbeat message from said remote unit within a predetermined time interval and reestablishes a connection to said remote unit over said satellite in response to said failure.

10. The communications unit of claim 7, in which said processor receives from said satellite information from said remote unit, comprising one of camera output and telemetry information.

11. The communications unit of claim 10, in which said processor controls display of said camera information to a user.

12. The communications unit of claim 10, in which said information further comprises information from sensors at said remote unit's location.

13. The communications unit of claim 7, in which said processor receives camera information and from said remote unit over said satellite.

14. The communications unit of claim 7, in which said processor receives remote control information from said remote unit, and uses said remote control information to control devices located at said unit.

15. The communications unit of claim 7, in which said processor sends information to a remote unit by way of a satellite ground station and a statellite.

16. The communications unit of claim 7, in which said processor is part of a computer system.

17. The communications unit of claim 7, in which said processor is firmware controlled.

18. A computer program product for improving the effective availability of a connection between terminals over a satellite link, comprising:
a. a memory medium; and
b. instructions stored on said memory medium for periodically sending a heartbeat message across the connection, for treating failure to receive a heartbeat message within a predefined interval as a disconnect; and for establishing a new connection between said terminals across the satellite link.

19. The computer program product of claim 18, in which said instructions further comprise instructions for turning off power to a satellite terminal and reapplying power to said terminal after a predefined interval.

20. The Computer Program product of claim 18, in which said instructions further comprise instructions for dialing a satellite gateway station or dialing the number of one of said terminals participating in said connection.
